(19) United States
(12) Patent Application Publication
(10) Pub. No.: US 2005/0217414 A1
(43) Pub. Date: Oct. 6, 2005

(54) Drive-by-wire assembly with force measuring sensor

(75) Inventor: Jeffrey G. Gibson, Bellaire, MI (US)

Correspondence Address: BANNER & WITCOFF LTD.,;ATTORNEYS FOR DURA AUTOMOTIVE, 28 STATE STREET - 28TH FLOOR, BOSTON, MA, 02109, US

(73) Assignee: DURA GLOBAL TECHNOLOGIES,INC., ROCHESTER HILLS, MI (US)

(21) Appl. No.: 10/814,559

(22) Filed: Mar. 30, 2004

(51) Int. Cl. G05G 1/14

(52) U.S. Cl. 74/560

(57) ABSTRACT

A drive-by-wire assembly for a motor vehicle including a foot engaging member configured to be engaged by a foot of a user. The foot engaging member is configured to remain substantially stationary when engaged by a foot of a user. A force measuring sensor is secured to the foot engaging member and is configured to provide an output signal based on a force applied by a foot of a user.

### FIELD OF THE INVENTION

This invention relates generally to a drive-by-wire assembly for a motor vehicle, and, in particular, to a drive-by-wire assembly for a motor vehicle that includes a force measuring sensor.

### BACKGROUND OF THE INVENTION

Historically, the pedals for operating a motor vehicle, for example, the accelerator, brake and clutch pedals, have included a mechanical linkage connecting the pedal to the device it is intended to operate. For example, the accelerator pedal may be connected by way of a cable to a throttle assembly, allowing the speed of the vehicle to be varied based on the amount the accelerator pedal is depressed by the user.

Drive-by-wire, e.g., pedal-by-wire, systems have been developed to eliminate the mechanical linkage between the pedal and the target device. These drive-by-wire systems reduce the number of moving parts and the weight of the system, and are intended to increase the accuracy and functionality of the system as well as reduce the service needs of the vehicle.

Many known drive-by-wire systems incorporate a sensor that measures the movement of the pedal. This measurement is converted into an electrical signal that is transmitted to the target device such as the throttle, braking assembly or clutch. The movement of a pedal in a conventional vehicle is substantial, and is typically two to three inches of travel.

Since such a sensor measures movement of the pedal, any movement, including unintentional movements, will be translated into a change in the output signal. Thus, expansion and contraction of the elements of the mechanical linkage due to temperature changes can affect the accuracy of such a system. Similarly, when a user's foot inadvertently engages the pedal in a non-desired direction, such as from the side or back of the pedal, the output signal can be affected. Consequently, the accuracy of these types of drive-by-wire systems can be affected by unintentional movements of the user's foot.

Additionally, the relatively large amount of movement required with these devices makes for uncomfortable ergonomics. The driver must initially place his foot in an uncomfortable position with the foresight that the moving pedal will eventually be comfortable through the travel range of the pedal. This movement through uncomfortable foot travel ranges can lead to fatigue and discomfort with time.

It is an object of the present invention to provide a drive-by-wire system with a force measuring sensor that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a drive-by-wire system with a force measuring sensor having increased accuracy and reliability.

In accordance with a first aspect, a drive-by-wire assembly for a motor vehicle including a foot engaging member configured to be engaged by a foot of a user. The foot engaging member is configured to remain substantially stationary when depressed by a foot of a user. A force measuring sensor is secured to the foot engaging member and is configured to provide an output signal based on a force applied by a foot of a user.

In accordance with another aspect, a drive-by-wire assembly for a motor vehicle includes a pedal configured to be engaged by a foot of a user. The pedal is configured to be substantially stationary when engaged by a foot of a user. A force measuring sensor is secured to the pedal and is configured to provide an output signal based on a force applied by a foot of a user. An electronic control unit is connected to the force measuring sensor and is configured to receive the output signal and output a control signal.

Substantial advantage is achieved by providing a drive-by-wire system with a force measuring sensor. In particular, the accuracy and reliability of the system controlled by the drive-by-wire system can be increased, and its service needs can be decreased, resulting in cost savings. Further, the chance of an output signal being produced from unintentional movement of the pedal is reduced.

These and additional features and advantages of the invention disclosed here will be further understood from the following detailed disclosure of certain preferred embodiments.

### BRIEF DESCRIPTION OF THE DRAWINGS

FIG. 1 is a side elevation view, shown partially in section, of a preferred embodiment of a drive-by-wire assembly in accordance with the present invention.

FIG. 2 is a side elevation view, shown partially in section, of an alternative embodiment of a drive-by-wire assembly in accordance with the present invention.

The figures referred to above are not drawn necessarily to scale and should be understood to provide a representation of the invention, illustrative of the principles involved. Some features of the drive-by-wire assembly with a force measuring sensor depicted in the drawings have been enlarged or distorted relative to others to facilitate explanation and understanding. The same reference numbers are used in the drawings for similar or identical components and features shown in various alternative embodiments. Drive-by-wire assemblies with a force measuring sensor as disclosed herein would have configurations and components determined, in part, by the intended application and environment in which they are used.

### DETAILED DESCRIPTION OF CERTAIN PREFERRED EMBODIMENTS

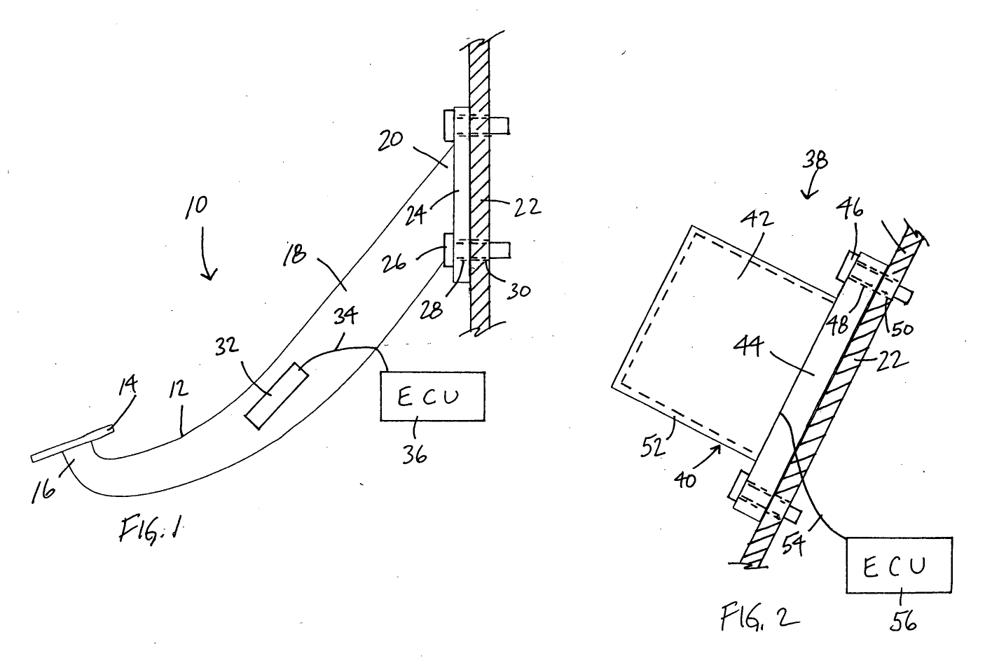

The present invention may be embodied in various forms. A preferred embodiment of a drive-by-wire assembly 10 is shown in FIG. 1. Drive-by-wire assembly 10 includes a foot engaging member such as a pedal 12. Pedal 12 includes a footpad 14 secured to a first end 16 of an arm 18. Footpad 14 is preferably covered with, or has a layer of, rubber or other suitable material to provide friction and a suitable gripping surface for the foot of a user. A second end 20 of arm 18 is secured to a front of dash 22 of a vehicle by way of a mounting member such as bracket 24. Bracket 24 is secured to front of dash 22 by way of fasteners such as bolts 26, which extend through apertures 28 in bracket 24 and apertures 30 in front of dash 22.

A force measuring sensor such as a strain gauge 32 is provided on drive-by-wire assembly 10. Strain gauge 32 sends an output signal by way of a cable 34 to an electronic control unit (ECU) 36. ECU 36 may contain signal conditioning devices such as an amplifier and noise reduction devices to clean up the signal received from strain gauge 32. ECU 36 may be a part of the target device controlled by drive-by-wire assembly 10, such as a throttle assembly, brake system, or clutch. Alternatively ECU 36 may be an independent unit that in turn sends a control signal to the target device. It is to be appreciated that strain gauge 32 need not be physically connected to ECU 36 by a cable, and that wireless connections are considered to be within the scope of the present invention.

When the user steps on footpad 14 of pedal 12, the force from their foot is measured by strain gauge 32, which transmits an output signal via cable 34 to ECU 36. ECU 36 then provides a control signal that is then used to control the target device. Unlike a conventional foot pedal in a motor vehicle, which typically has a foot travel of approximately 2-3 inches, pedal 12 remains substantially stationary when engaged by the user's foot. Due to the force of the user's foot and the laws of physics, the components of pedal 12 of drive-by-wire assembly 10, that is, footpad 14, arm 18, mounting bracket 24 and a portion of front of dash 22, will necessarily move slightly. However, such movement is negligible when compared to the typical 2-3 inch travel of a conventional pedal, and such movement will generally not be identified as significant by the user.

By providing a drive-by-wire assembly with force measuring sensor on a foot engaging member that is substantially stationary when engaged by the foot of a user, the present invention reduces the number of parts and, especially advantageously, reduces the number of moving parts required to control a target device such as a throttle assembly, braking system or clutch. This reduction in parts will result in reduced manufacturing and maintenance costs, and the design of the drive-by-wire assembly will improve the accuracy of the system.

In the illustrated embodiment strain gauge 32 is directly secured to arm 18. It is to be appreciated that strain gauge 32 could be secured to any portion of drive-by-wire assembly 10 that is exposed to the force applied by the user's foot. In other words, strain gauge 32 can be placed anywhere along the load path of the force imparted by the user's foot. Thus, strain gauge 32 could, for example, be directly secured to footpad 14 or mounting bracket 24 in other embodiments.

Another embodiment is shown in FIG. 2, in which a drive-by-wire assembly 38 includes a foot engaging member 40 including a force measuring sensor 42. Foot engaging member 40 is illustrated here as a pad or button-like member secured to front of dash 22. Foot engaging member 40 includes a base plate 44 that is secured to front of dash 22 by way of fasteners such as bolts 46, which extend through apertures 48 in base plate 44 and apertures 50 in front of dash 22. In a preferred embodiment, foot engaging member 40 includes a cover 52 surrounding force measuring sensor 42 to provide an improved gripping surface for the user's foot. Cover 52 may be formed of rubber or any other suitable material that provides friction and grip for the user's foot. As described above with respect to the embodiment described with respect to FIG. 1, force measuring sensor 42 sends an output signal by way of a cable 54 to ECU 56, which then sends a control signal to a target device.

In one preferred embodiment, force measuring sensor 42 is a load sensor. In another preferred embodiment, force measuring sensor 42 could be a Hall-effect sensor excited by a spring and magnet assembly in which the user, when pressing on the pedal, activates the spring to move a magnet to create a change in the magnetic field formed on a plate of semi-conductive material to provide a variable output voltage. It is to be appreciated that other force measuring sensors that are not dependent on an extensive path of travel of a pedal or other foot engaging member are considered to be within the scope of the present invention, and other suitable force measuring sensors will become readily apparent to those skilled in the art, given the benefit of this disclosure.

Although drive-by-wire assembly 38 is illustrated here as being secured to front of dash 22, it is to be appreciated that in other preferred embodiments, drive-by-wire assembly 38 may be secured to the floor of the motor vehicle.

The configuration of the drive-by-wire system of the present invention allows a user to position their foot comfortably and then apply pressure with their foot. Since the foot engaging member does not move, the user does not have to position their foot initially in an uncomfortable or unnatural position, with their foot moving to a comfortable position after some travel distance. They merely find a comfortable position for their foot and then apply pressure.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A drive-by-wire assembly for a motor vehicle comprising, in combination;
a foot engaging member configured to be engaged by a foot of a user, the foot engaging member configured to remain substantially stationary when engaged by a foot of a user;
a force measuring sensor secured to the foot engaging member and configured to provide an output signal based on a force applied by a foot of a user.

2. The drive-by-wire assembly of claim 1, wherein the force measuring sensor is a strain gauge.

3. The drive-by-wire assembly of claim 1, wherein the force measuring sensor is a load cell.

4. The drive-by-wire assembly of claim 1, wherein the force measuring sensor is a Hall-effect sensor.

5. The drive-by-wire assembly of claim 4, wherein the Hall-effect sensor is excited by a spring and magnet assembly.

6. The drive-by-wire assembly of claim 1, wherein the foot engaging member is a pedal.

7. The drive-by-wire assembly of claim 6, wherein the pedal comprises an arm having a first end and a second end, and a footpad secured to the first end, the second end being secured to a mounting member.

8. The drive-by-wire assembly of claim 7, wherein the mounting member is configured to be secured to a front of dash of a vehicle.

9. The drive-by-wire assembly of claim 1, wherein the foot engaging member is an accelerator pedal.

10. The drive-by-wire assembly of claim 1, wherein the foot engaging member is a brake pedal.

11. The drive-by-wire assembly of claim 1, wherein the foot engaging member is a clutch pedal.

12. The drive-by-wire assembly of claim 1, wherein the foot engaging member is a suspended pedal.

13. The drive-by-wire assembly of claim 1, wherein the foot engaging member is configured to be secured to a front of dash of a vehicle.

14. The drive-by-wire assembly of claim 1, further comprising a cover for the foot engaging member.

15. The drive-by-wire assembly of claim 1, further comprising an electronic control unit configured to receive the output signal from the force measuring sensor.

16. The drive-by-wire assembly of claim 1, further comprising a cable to connect the force measuring sensor to the electronic control unit.

17. A drive-by-wire assembly for a motor vehicle comprising, in combination;
a pedal configured to be engaged by a foot of a user, the pedal configured to be substantially stationary when engaged by a foot of a user;
a force measuring sensor secured to the pedal and configured to provide an output signal based on a force applied by a foot of a user;
an electronic control unit connected to the force measuring sensor and configured to receive the output signal and output a control signal.

18. The drive-by-wire assembly of claim 17, wherein the force measuring sensor is a strain gauge.

19. The drive-by-wire assembly of claim 17, wherein the force measuring sensor is a load cell.

20. The drive-by-wire assembly of claim 17, wherein the force measuring sensor is a Hall-effect sensor.

21. The drive-by-wire assembly of claim 20, wherein the Hall-effect sensor is excited by a spring and magnet assembly.

22. The drive-by-wire assembly of claim 17, wherein the pedal is an accelerator pedal.

23. The drive-by-wire assembly of claim 17, wherein the pedal is a brake pedal.

24. The drive-by-wire assembly of claim 17, wherein the pedal is a clutch pedal.
